(19) United States
(12) Patent Application Publication
(10) Pub. No.: US 2002/0138780 A1
(43) Pub. Date: Sep. 26, 2002

(54) Clock generator for generating a frequency-jittered system clock

(76) Inventor: Christian Bock, Freiburg (DE)

Correspondence Address: Samuels, Gauthier & Stevens LLP, 225 Franklin Street, Suite 3300, Boston, MA, 02110, US

(21) Appl. No.: 10/033,719

(22) Filed: Dec. 26, 2001

(30) Foreign Application Priority Data
Mar. 21, 2001 (EP) 01106972.1
Dec. 23, 2001 (DE) 100 65 072.4

(51) Int. Cl. G06F 1/04; G06F 1/06

(52) U.S. Cl. 713/500

(57) ABSTRACT

A clock generator (100) with a random-number generator (1) and a phase modulator (4) is disclosed for generating a frequency-jittered system clock (cl), which thus causes minimal radiated interference. Between the random-number generator (1) and the phase modulator (4), an integrator (3) is connected for integrating the random numbers (z1) provided by the random-number generator. The output of the integrator (3) controls the respective phase value (pa) in the phase modulator (4). The integrator (3) is coupled to a checking facility (7) which interferes in the random numbers (z1, z2) and intervenes in the integration process so that predetermined limit values (G1, G1′; G2, G2′; G3, G3′) are not exceeded during the integration.

### BACKGROUND OF THE INVENTION

The present invention relates to the field of clock generators for digital systems, and in particular to a clock generator for generating a frequency-jittered system clock.

Such a clock generator and a method of generating such a system clock therewith are disclosed, for example, in the assignee's of the present invention co-pending European Patent Application EP 0 715 408 A1. This co-pending application discloses a system clock of high frequency accuracy, that is generated by phase-modulating a basic clock signal of stable phase and frequency by a phase modulator, which is controlled with random numbers from a random-number generator.

If the system clock is to function reliably in practical applications, however, the phase deviations must not be too great, because otherwise, in the case of very short clock phases, the remaining processing time in some subcircuits controlled by the system clock will not be sufficiently long. Therefore, minimum values are specified for the high and low clock states, below which the clock phases must not fall. As system clock generators operate close to the technological limit, so that as many functions per unit time as possible can be performed, substantial shortening of the clock phases is generally not possible. This also limits the phase modulation range, however, so that the frequency jitter region of the system clock, and hence the effect on the reduction of radiated interference, will also remain relatively limited.

Therefore, there is a need for an improved system clock generator with reduced radiated interference.

### SUMMARY OF THE INVENTION

Briefly, according to an aspect of the present invention, a clock generator includes an integrator inserted between a random-number generator and a phase modulator, for integrating the random numbers. This represents a transition from the random-number-controlled phase modulation to a random-number-controlled frequency modulation. On the other hand, phase modulation is not abandoned completely, since the respective phase shifts produced are linked directly to the random numbers. The maximum amount of the phase shifts can thus be controlled in a simple manner via the allowed range of the random numbers. If the random numbers are not produced as pseudorandom numbers with a limited range, separate range limiting will be necessary, which can be implemented, for example, by ignoring the overflow or by a modulo operation. By accumulating the individual phase shifts in accordance with an aspect of the invention, the permissible jitter region can become substantially greater than with pure phase modulation. On the other hand, it must be ensured that the phase and, thus, the frequency do not vary too much from the desired phase and desired frequency, respectively. Otherwise arbitrary values could be reached during the accumulation of the random numbers, irrespective of whether positive, negative, or positive and negative random numbers are allowed. In any case, a suitable strategy must be provided which prevents the permissible range from being exceeded. This must take into consideration that the selected strategy interferes in the random number sequence and thus replaces this sequence in part by a deterministic sequence. On the other hand, the randomness is a prerequisite for the fact that the current pulses of the connected processing stages, which are locked to the clock signals, contain no emphasized harmonic components, as far as this is possible. Thus, the strategy should interfere in the random number sequence as little as possible. An analysis of the various strategies by suitable computer simulations clearly shows the different effects and permits an optimization according to the respective operating parameters, such as the frequency of the system clock, the minimum permissible clock phase, the allowed frequency or phase range, but also the amount of circuitry required. In many cases, limits to be specified may differ during normal operation: for example, narrower limits during first time intervals and wider limits outside these time intervals. This, of course, has a favorable effect on the jitter. However, it must be ensured by the return strategy selected that the narrower limits are reached again at the beginning of the first time intervals at the latest. Conversely, it follows from the strategy how much the frequency and phase may deviate from the desired value during the second time intervals.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a block diagram of an embodiment of a clock generator;

FIGS. 2 and 3 illustrate possible phase shifts at a clock pulse edge;

FIG. 4 illustrate a ring oscillator used as a phase modulator;

FIG. 5 illustrates s a timing diagram showing some phase-shifted clock pulse edges;

FIG. 6 shows schematically two different-sized phase location ranges with random numbers;

FIGS. 7-12 are plots of examples of phase location ranges as a function of the selected system clock frequency;

FIG. 13 shows a portion of a checking facility;

FIG. 14 shows a processing table relating thereto;

FIG. 15 shows another subcircuit of the checking facility; and

FIG. 16 is a block diagram of a parallel processing arrangement.

### DETAILED DESCRIPTION OF THE INVENTION

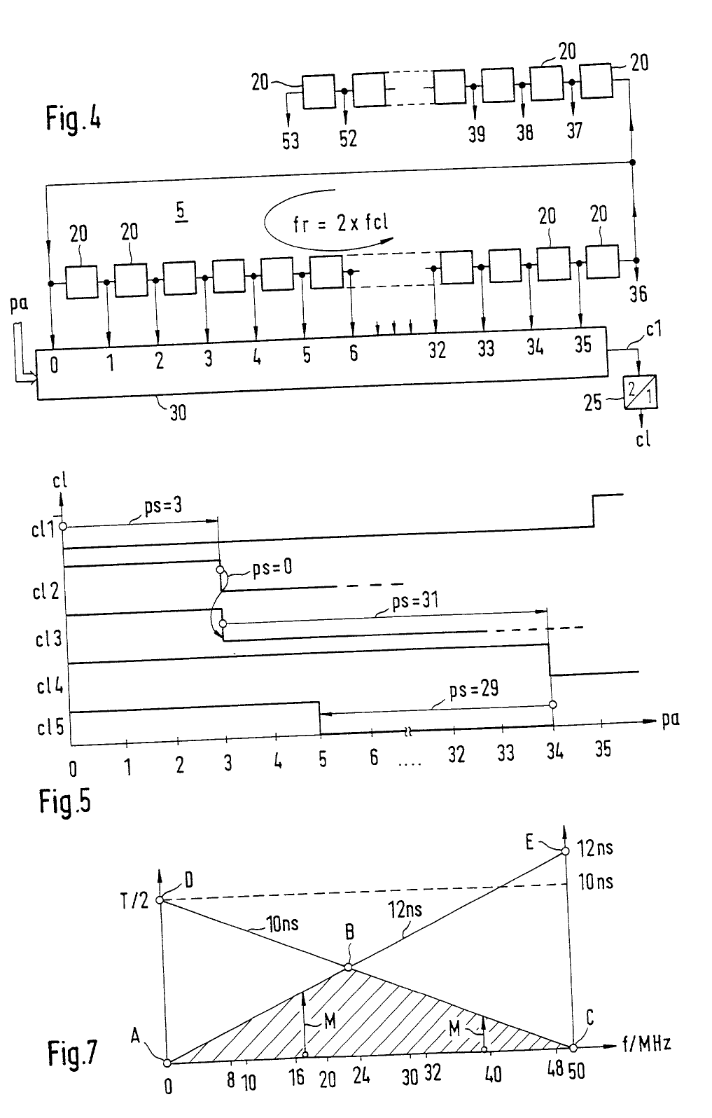

FIG. 1 shows an embodiment of a clock generator 100. A random-number generator 1 produces random numbers z1 and supplies the latter through a delay unit 2 to an integrator 3. The integrator 3 integrates the applied random numbers z2, z3, which may be positive or positive and negative. The integral pa of the random number z1, z2 is fed to a phase modulator 4, whose output is coupled to a controlled oscillator 5, whose respective phase is dependent on the integral pa. Oscillator 5 may form part of a phase-locked loop PLL comprising a reference oscillator 6 and a ring oscillator whose total delay is controlled by reference oscillator 6. The ring oscillator has a plurality of individually controllable taps which provide the system clock cl in different phases. The individual delays are equal to only fractions of the system clock period; for example, a half clock period may be divided by 35 delay stages into 35 different clock phases. Phase modulator 4 and oscillator 5 may also be combined, as shown in FIG. 4.

The above-described signal path for generating the system clock cl is influenced by a checking facility 7 comprising an integrator simulator 8, a comparator 9, and a selection unit 10. The checking facility further includes memories 11, 12, 13 for first, second, and third limit values G1, G2, G3 and, if necessary, associated opposite limit values G1′, G2′, G3′, which can be fed to the integrator simulator, the comparator, and the selection unit via a data bus 19. The opposite limit values are preferably the reference phase values pa=0 or the negated limit values G1, G2, G3, in which case the separate storage is not necessary.

Integrator simulator 8 checks whether after the integration step, the new random number z1 remains within the second or third limit values G2, G2′, G3, G3′. To this end, the integrator simulator is fed with the current integral pa, and the new random number z1 is added or subtracted, depending on the sign. The integral j is compared in comparator 9 with the limit values G2, G2′, G3, G3′, and the result of the comparison is fed to selection unit 10. The latter incorporates a modification device 17 that provides a modified random number z3, which is fed instead of the delayed random number z2 to the input of integrator 3 via an electronic switch 14. Selection unit 10 contains the logic for deciding whether the random number z1 is to be integrated or in what way the modification must be carried out to meet the respective limits.

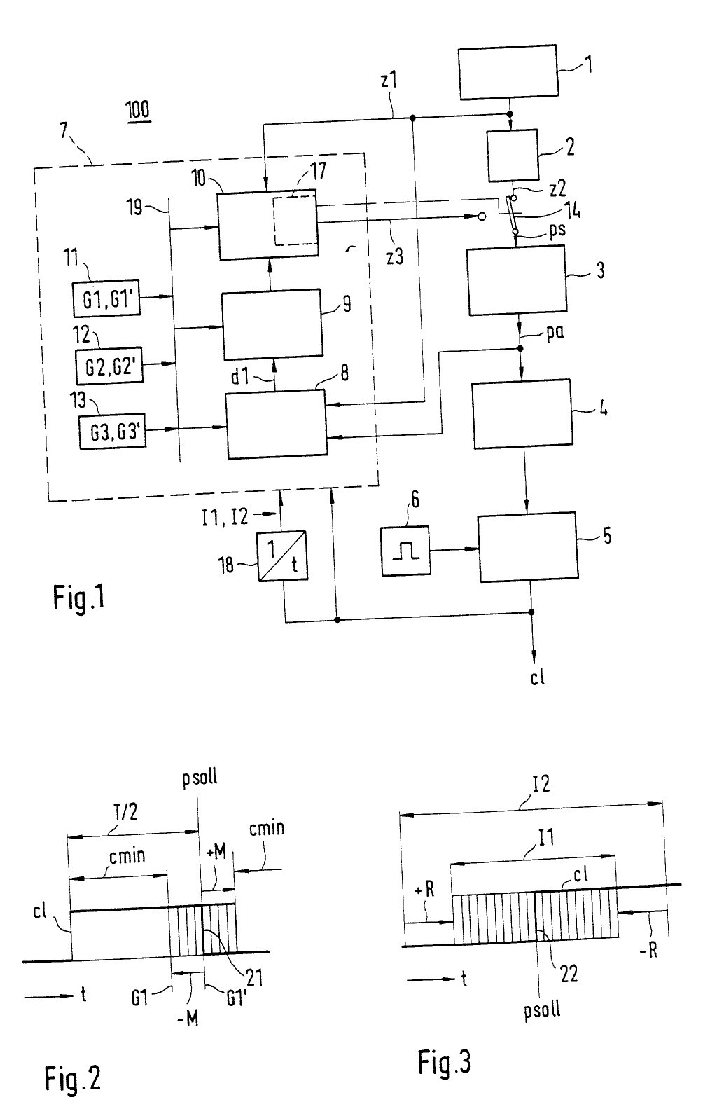

FIG. 2 illustrates by the example of a trailing edge 21 of a system clock pulse cl how this edge can be varied in the positive or negative time direction by the individual phase steps ps. The clock phase must not fall below the minimum permissible value cmin, corresponding to a lower limit, the first limit value G1, because otherwise the signal processing time in the connected circuit blocks would become too short. Starting from the desired clock period or desired phase psoll, a maximum shift reducing the active clock phase, a shift −M, is obtained, which must not be exceeded in any case. The phase shift increasing the active clock phase is not subject to this limitation. For reasons of expediency, however, the positive phase shift is limited to the same amount M. FIG. 2 shows the maximum shift +M, and the associated upper limit value is G1′. The limits G1, G1′ define a phase location range A0 which corresponds to the permissible phase location range with pure phase modulation, that is without integrator 3. If the phase shift does not start from the desired phase, the maximum shift up to the limit G1, G1′ can be correspondingly greater or smaller. In the limiting case, the maximum shift extends from one limit to the other.

FIG. 3 shows schematically the location range of a leading edge 22 in a first or second time interval. This case is of interest when the edge may temporarily depart from the desired phase psoll farther than is FIG. 2 without violating the requirement for the minimum clock phase cmin. That will be the case if the individual phase steps ps do not exceed the maximum permissible shifts M, −M (e.g., those of FIG. 2). The limits for this location range A1 are represented by G2, G2′, with the range advantageously extending symmetrically about the desired phase psoll. As a rule, this location range A1 should be greater than location rang A0. This does not apply at low clock frequencies; cf. in FIG. 7 the frequency range below 24 MHz.

If an even greater phase location range A2 is allowed in the second time interval, a suitable return strategy +R, −R must ensure that the limits G2, G2′ are reached again at the beginning of the first time interval at the latest. Suitable return strategies R for meeting the limits of the phase location ranges A0, A1, A2 will be explained in detail later.

FIG. 4 shows schematically an embodiment of a phase-controlled oscillator 5 that is designed as a ring oscillator. The ring oscillator contains 35 series-connected delay stages 20 whose total delay is adjusted to one-half the period of the system clock cl, T/2, by the phase-locked loop PLL (not shown in detail). The taps at the individual delay stages are connected to a multiswitch 30 which, depending on the associated integral pa, which represents the accumulated phase value, selects one of these taps and applies the tapped signal as an auxiliary clock cl', which has twice the frequency of the system clock cl, to a frequency divider 25. The output of this frequency divider provides the system clock cl, which is amplified by a driver stage (not shown). By the auxiliary clock, the leading and trailing pulse edges of the system clock are modified in phase independently of each other.

The arrangement shown in FIG. 4 is advantageous if the desired phase is at the zero reference phase value pa=0 and the individual delay steps ps delay the auxiliary clock cl' with respect to this reference phase. If positive and negative phase steps +ps, −ps are provided, it is more appropriate to connect the reference phase not to the beginning of the delay chain, but to a subsequent tap. In order that the range of permissible positive and negative phase steps is not restricted, it is also advantageous to connect to the end 36 of the delay chain another, not too short delay chain, here with the taps 37 to 53, which, however, does not lie within the closed ring but requires for each tap an associated input (not shown in FIG. 4) at the multiswitch 30. The attached delay chain with the taps 37 to 53 eliminates the conversion of the original taps 0 to 35 on the occurrence of phase steps that are greater or smaller than this range.

FIG. 5 shows some phase-shifted clock pulse edges in a timing diagram. The trailing edge of the first clock pulse cl1 begins at the reference phase 0, which corresponds to the accumulated phase value pa=0, and the leading edge begins at the accumulated phase value pa=35, because the half clock period T/2 is divided by 35 delay stages 20 into 35 clock phases. For the second clock pulse cl2, three phase increments ps=3 are provided, so that the trailing edge is located at the accumulated phase value pa=3. The next phase step has the value ps=0, so that for the third clock pulse cl3, the accumulated phase pa at 3 does not change. The next phase step ps=31 shifts the accumulated phase of the fourth clock pulse cl4 to the phase value pa=34. The next phase step is negative with ps=−29 and shifts the phase of the fifth clock pulse cl5 to the accumulated phase value pa=5.

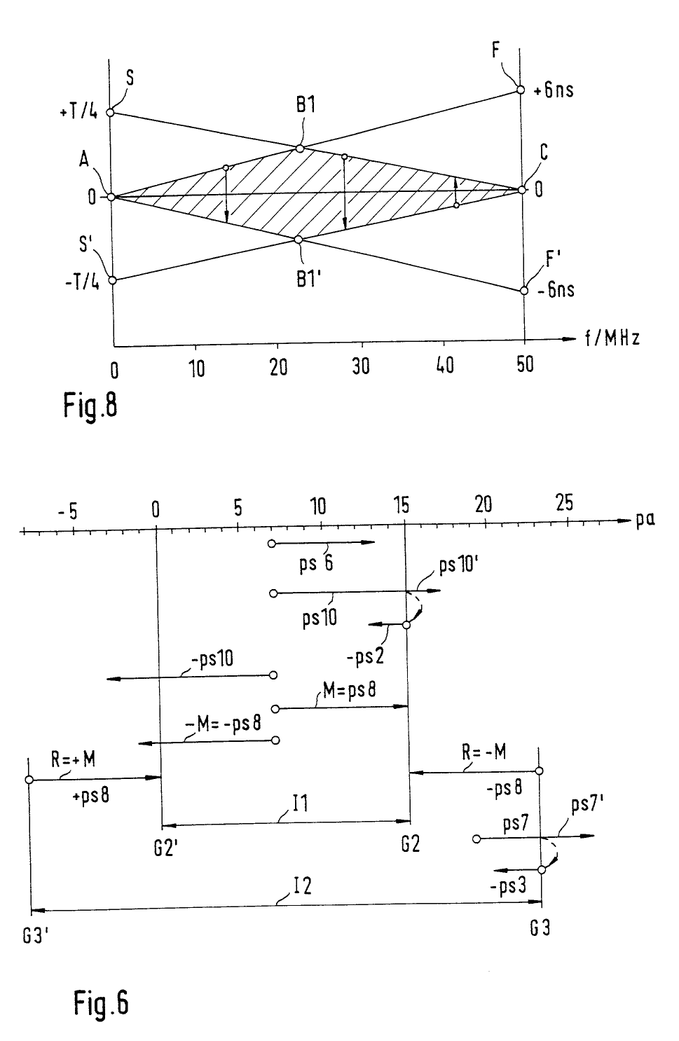

In the timing diagram in FIG. 5, range limits do not yet occur. The relationship between phase steps and range limits are shown in FIG. 6. The second limit value G2 and the associated opposite value G2′ define a first phase location range A1, and the third limit value G3 and the opposite value G3′ define an extended phase location range A2. A scale shows accumulated phase values pa. The scale range extends asymmetrically from −8 to 23. The first phase step ps6, which extends over six phase increments and starts at the phase value pa=7, lies completely within the first location range A1. The phase step ps10, which starts at the same phase value, would extend to the phase value 17, which lies outside the first range A1. To meet the limit G2′, a so-called mirroring method is carried out, in which the phase step ps10′ going beyond the limit G2′ is mirrored and corresponds to a negative phase step −ps2, which starts from the limit G2′. Instead of the phase value 17, the phase value 13 is produced by the mirrored phase step ps10. This corresponds to a resultant phase step ps*6 of 6 phase units.

This method permits relatively great phase steps ps, but requires a certain amount of computation. The greatest possible resultant phase step extends from limit G2 to limit G2′ or conversely, provided that the maximum permissible shift M, which follows from the cmin requirement, is not exceeded.

Starting from phase value 7, the negative phase step −ps10 exceeds the lower limit G2, which is at the phase value 0. If all the phase steps ps are to lie within the limits G2, G2′ without the mirroring method being used, this defines a maximum shift M, which in the example of FIG. 6 corresponds to the phase step ps=8. This is the greatest phase step which, starting from the middle phase value or phase pair (pa=7, pa=8), exceeds one of the two limits G2, G2′ at the most but remains within the other limit G2′, G2. The exact maximum step size M' corresponds to the rounded-up half of the first range A1. The fact that the negative maximum shift −M', which starts from pa=7, lands outside the lower limit G2 is irrelevant if for the maximum shift to be integrated, M', the sign +/− is specified by the modification device 17 in the correct manner. This maximum shift, which starts from the middle of the range, is approximately half as great as the resultant maximum shift that is possible with mirroring, M*. In the following, only “M” is given as the maximum shift so as not to limit the respective strategy (mirroring or reversal of direction) for defining the maximum shift. It is apparent from the representations which maximum shift M*, M' is meant.

In FIG. 6, the extended phase location range A2 with the limits G3, G3′ is determined by a specific return strategy R with which the first range A1 must be reachable again by a single maximum shift M (e.g., M* or M'). To meet the limits G3, G3′, there are again various possibilities, with the depicted phase step ps7 again serving as an example for the mirroring method. In the following, some return strategies that can be used for the first or second range A1, A2, but partly also for the range A0, are briefly listed:

1. Replace at least one random number to be integrated by a predetermined phase shift, particularly by the maximum shift M, or by a predetermined sequence of phase shifts.

2. Replace at least one random number to be integrated by mirroring the excess value at the respective limit.

3. Replace at least one random number to be integrated by a change in direction effected by a sign inversion.

4. Replace at least one random number to be integrated which goes beyond the range between the third limits G3, G3′ by a substitute value which guarantees the return to the range between the second limits G2, G2′ at a predetermined point of time.

5. Repeat the last random number sequence, or repeat the last random number sequence in reverse order of time, or repeat the last random number sequence in a random time sequence, possibly with reversed signs.

6. Suppress the respective random number formed until a suitable random number appears.

7. Combinations of the above return strategies (e.g., No. 1 and No. 3).

FIGS. 7-12 diagrammatically illustrate examples of location ranges of the accumulated phases pa as a function of the selected frequency of the system clock cl. The horizontal axis measures frequency from 0 to 50 MHz. In the vertical direction, a half clock period T/2 is plotted on the left-hand side, which corresponds to the delays of all the ring-connected delay stages 20, for example 35 delay stages as in FIG. 4. Thus, the respective number of delay stages 20 is defined according to the projection on this arrow.

The 10−ns line from D to C applies for the assumed case where the respective clock phase must be at least 10 ns. The vertical arrow on the right-hand side is also scaled with the half clock period T/2, but the point plotted on this arrow represents the maximum permissible phase value of the first range A1. Therefore, line AE describes the accumulated phase value pa, which must not be exceeded so as not to violate the exemplary 12−ns range. By contrast, line DC defines the limit for the accumulated phase values that must not be exceeded because of the 10 ns minimum phase range. Therefore, the maximum possible shifts M are defined, on the one hand, by line AB and, on the other hand, by line BC. With pure phase modulation, the triangle ABC defines the location area for the phase values under the specified conditions, that is 10−ns minimum phase location range and 12−ns phase location range. All phase values can be produced directly by the random-number generator.

Line DC of FIG. 7 shows that in the illustrated example, at a low clock frequency of 4 MHz, the requirement for a sufficiently long and active clock phase whose limit is defined by cmin is satisfied nearly throughout the half clock period T/2. For the sake of completeness it should be pointed out that the range from T/2 to T is the inactive range of the clock phase, in which the clock signal is shifted in phase by 180 degrees. At a high clock frequency of, for example 48 MHz, the half clock period T/2 is very short, namely only 10.4 ns. Here, the limit value cmin equal to 10 ns would already be reached with a negative phase shift of −0.4 ns. With a smallest phase step size between 0.21 and 0.39 ns, this would be just one phase step. Assuming that twenty delay stages are used per half clock period T/2, the smallest phase step size already has a value of 0.52 ns. With this value, the condition cmin equal to 10 ns can not be met. In that case, the clock phase can no longer be varied and would be fixed. To be able to implement the desired phase variation of the clock signal at this frequency, the number of delay stages would have to be substantially increased.

Line AE of FIG. 7 shows that at a low clock frequency of 4 MHz, for example, the requirement to remain within the 12−ns phase location range is difficult to meet, because as a result of the low clock frequency, the individual phase steps become relatively great in comparison with the 12−ns location range. With the aforementioned delay chain of 20 stages for T/2, each delay stage corresponds to a phase step of approximately 6.2 ns. Hence, the assumed location range of 12 ns permits only a single phase step without limit violation. In this case, too, a substantial increase in the number of delay stages is necessary to reduce the size of the phase steps and thus permit a variation of the clock phase.

At a high frequency of 48 MHz, for example, meeting the limits of the 12−ns location range is uncritical, because the phase steps are fine compared to 12 ns, namely about 0.52 ns in the case of 20 delay stages over T/2, corresponding to the example assumed above. The resulting phase location area ABC follows from the preceding considerations, with the limits being determined by the respective less favorable conditions. The most favorable range for the selection of the clock frequency and of the number of delay stages can be easily determined from such a plot. For the assumed parameters of the plot of FIG. 7, it lies approximately in the middle frequency range at 24 MHz, where the maximum permissible phase shift M is greatest and thus permits the greatest phase variation.

In the plot of FIG. 7 and the following plots, the maximum phase shift M is defined by the distance between the limits according to FIGS. 7 and 8, which applies for the respective clock frequency and pure phase modulation. The phase shift extending from limit to limit uses the above-explained mirroring at the limit as a return strategy. The maximum possible step size thus extends from one limit to the other.

FIG. 8 again shows the phase location range with pure phase modulation, for example without integrator, but the location range for the permissible phases is symmetrical about the reference phase value 0. The 12−ns range is thus constituted by the range from −6 ns at F' to +6 ns at F. The size of the maximum shifts M with mirroring has not changed, but the shifts are effected via the zero reference phase. The location area for pure phase modulation, formed by the rhombus A, B1′, C, B1, is the same size as the area ACB of FIG. 7. Since the 10−ns limit also extends uniformly on both sides of the respective clock pulse edge, the associated limit curves (SC and S'C) begin at T/4 and −T/4, respectively.

The phase location range of FIGS. 7 and 8 corresponds to that for a clock generator without integrator. The representation serves to explain certain fundamental terms, which are also used in connection with the following plots.

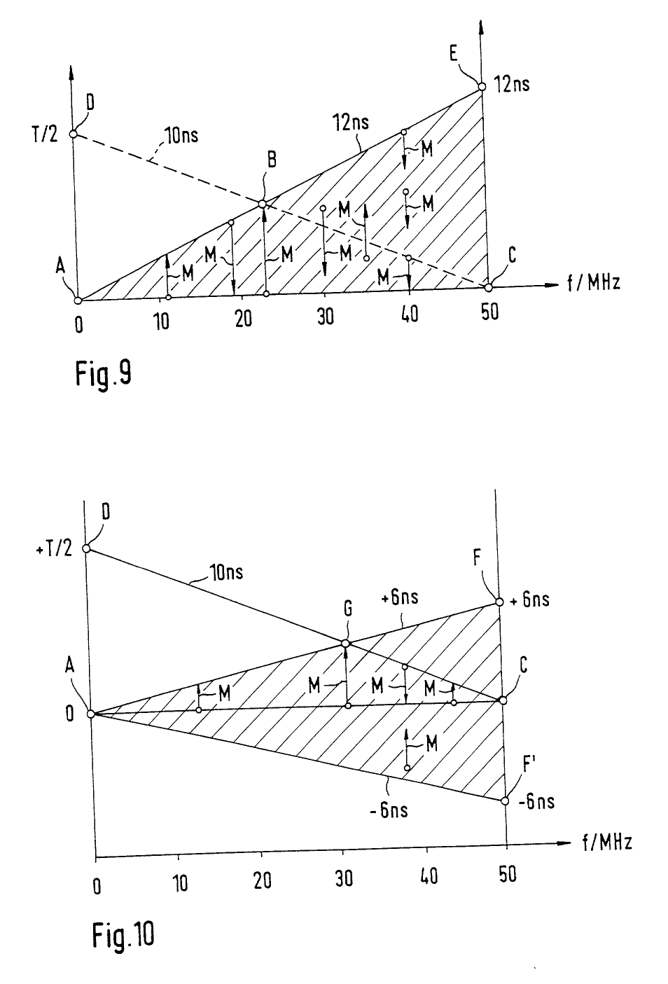

FIG. 9 shows the phase location plot for a clock generator with an integrator according to the invention, with the requirements on the system clock being the same as in FIGS. 7 and 8. FIG. 9 shows the unsymmetrical case, which starts from phase reference value 0 and has positive phase deviations. Compared to FIG. 7, the hatched area ACE has increased by the area BCE. The conditions for the maximum shift M are given by lines AB and BC. The arrows shown all correspond to the maximum shifts assigned to the respective frequency. At 40 MHz, three maximum shifts M lying one above another show that the location range there is substantially greater than the maximum permissible shift M at this frequency. Here, the location range obtained by frequency modulation, A1, is greater than the location range defined by the maximum permissible shift M, that is the range A0.

The plot of FIG. 10 differs from the plot of FIG. 9 only in that the limits are assumed to be symmetrical about the phase reference value 0. At low frequencies, the maximum shifts are limited by the 6−ns boundary lines from A to B1 and from A to B1′. The greatest maximum shift M is reached at B1, B1′ and is equal to the maximum shift at B in FIG. 9. The two 5−ns boundary lines, as in FIG. 8, run from S to C and from S' to C; the points of intersection with lines AF and AF' are B1 and B1′. The area AF'F is identical to the area ACE of FIG. 9.

The plots of FIGS. 11 and 12 are partly identical to the plots of FIGS. 9 and 10, respectively, and include in particular the respective location areas ACE and AF'F. In addition, however, the plot of FIG. 11 includes supplementary location areas EHIJ and CH'I'J', and that of FIG. 12 includes supplementary location areas FKLN and F'K'L'N'. These location areas follow from the fact that according to FIG. 3 or FIG. 6, an extended location range A2 applies at least for the second time intervals. However, by a single maximum shift M, the limits of the 12−ns location areas A1, ACE, and AFF' can be reached again. The second time intervals are determined by the frequency divider 18 of FIG. 1, for example. Assuming a relatively high-frequency system clock cl, data are scanned via an external bus at a substantially lower clock rate, for example, for which the relatively narrow 12−ns phase limits are necessary. Outside this specific data transfer, however, the phases may vary by greater amounts, which corresponds to the additional areas of FIGS. 11 and 12.

The limits IJ, I'J' and LN, L'N' are linked with the division ratio of the divider 18, which is given in FIGS. 11 and 12 as t:1. If divider 18 is not present, the division ratio will be 1:1 and the more restricted location condition A1 will have to be satisfied. Only at a division ratio of 2:1 will an extended location range A2 be possible for every other clock pulse. The first clock pulse has a narrow location range A1, the next a wide one A2, the third again a narrow one A1, etc. if, for example, a fixed frequency of 8 MHz is specified for the scanning of the narrow location range A1, then the divider 18, according to the plots covering the range from 0 to 40 MHz, can have a division ratio of 6:1 at the most. The system clock cl will then have a maximum frequency of 48 MHz, and the maximum phase shift M with 20 delay stages will only amount to a single phase step. However, the phase location range in FIG. 11 extends from C to nearly E or in FIG. 12 nearly from F' to F. The implementation of the negative phase region CH'I'J' with respect to the reference phase pa equal to 0 requires a suitable design of the delay unit or this negative phase region must be omitted. If, however, the reference phase pa equal to 0 lies in the middle area of the delay chain, the negative phases are easy to realize. The plot for this is shown in FIG. 12.

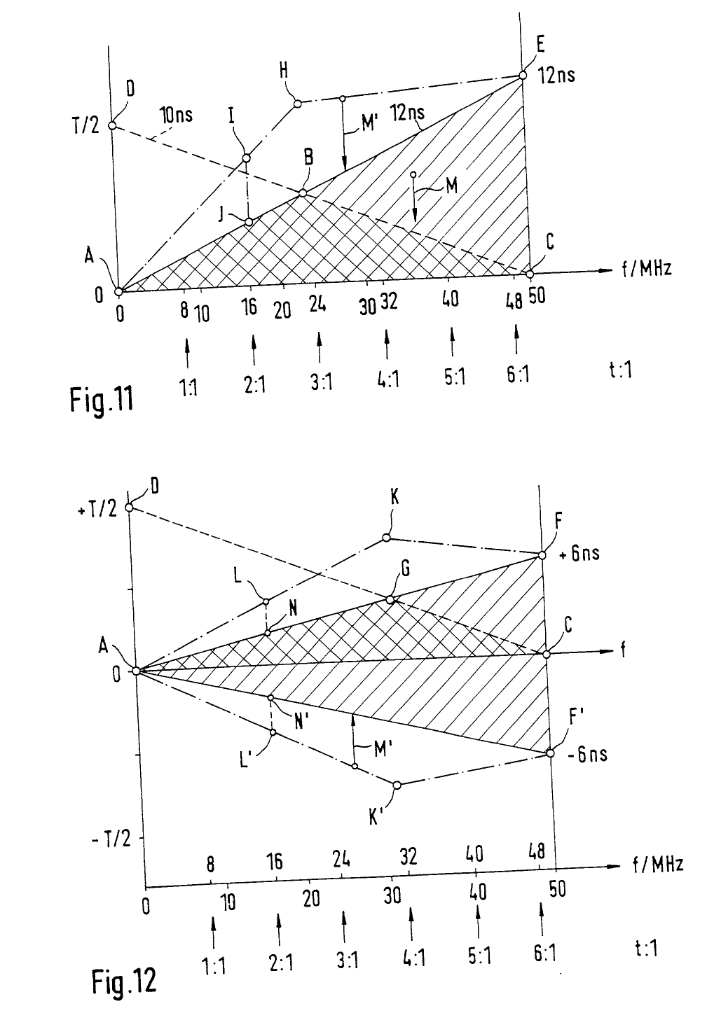

The block diagram of FIG. 13 shows an example of a subcircuit of checking facility 7 for effecting a sign reversal when a range is exceeded. The random number z1 produced by random-number generator 1 is fed to an integrator simulator 8, which contains an adder-subtracter as an arithmetic unit 38. Depending on the sign of the random number z1, arithmetic unit 38 forms the sum or difference of the old integral j⁻¹ and the new random number z1. The result of this arithmetic process is a test integral j, which is fed to the adding inputs of first and second arithmetic units 42, 43 in comparator 9.1. These two arithmetic units 42 and 43, which serve as adders or subtracters, receive at their subtracting inputs the limit values G2′ and G2, respectively, which are read from memory 12 and subtracted with correct sign from the test integral j. If the limit G2′ is exceeded, that is if j is greater G2′, the first arithmetic unit 42 will provide an output value greater than 0. If the test integral is below the limit G2 (i.e., if j<G2), the second arithmetic unit 43 will provide an output value less than 0. If two's complement numbers are used for the random numbers z1 and their subsequent processing, the most significant bit (MSB) will indicate the respective sign—“0” is positive and “1” is negative. Thus, of the output values of arithmetic units 42, 43, only the MSB must be checked in first and second to comparing elements 44, 45. The comparison provides a first logic signal a, and a second logic signal b. These and a third logic signal c, which corresponds to the sign or the MSB of the random number z1, are applied to a selection unit 10.1. The latter combines the three logic signals a, b, c using a combination of an OR gate 46 and an AND gate 47, which has a negative input 48 for the logic signal b. The result of this logic operation is a fourth logic signal d, which is fed as a control signal to a first subcircuit 17.1 of modification device 17. Depending on the state of the logic signal d, subcircuit 17.1 provides as its output value k the original random number z1 or the random numbers z2, delayed by delay element 2, or another number, such as a random number z1.

The table shown in the first subcircuit 17.1 indicates how the output value k is linked with the original random number z1 and the control signal d. When the signal d is at logic 0, the output number k is a positive number, regardless of the sign of the original random number z1. When the signal d is at logic 1, the output number k is a negative number, regardless of the original sign of the random number z1. The relationship between the logic signal d and the processing of the original random number z1 is illustrated in detail in the table of FIG. 14. With the number k provided by modification subcircuit 17.1 it is ensured that during the integration of this number k in integrator 3, the limits G2′, G2 are not exceeded. Depending on the sign of k, the absolute value of k is added to or subtracted from the integral j⁻¹, thus forming the new integral j', which is available at the output of an accumulator unit 40. This new integral is fed to an accumulator register 41. In the next comparison phase, it serves as an old integral j⁻¹.

At some of the data lines, the necessary number of bits is indicated beside a small oblique stroke. For example, the random number z1 has five bits, the output of integrator simulator 8 has seven bits, and the outputs of arithmetic units 42, 43 and of comparing elements 44, 45 have one bit each.

FIG. 14 shows in the form of a table the function of the first modification subcircuit 17.1 of FIG. 13. The individual columns 1 to 7 contain:

1. The row number “Nr.” of the table.

2. The random number to be integrated, “z1”.

3. The first, second, and third logic signals “a”, “b”, and “c”.

4. The resulting logic signal “d”.

5. The integral “j” formed in integrator simulator 8.

6. The operation to be performed in integrator 3, i.e., whether the absolute value of the random number z1 has to be added or subtracted.

7. The mathematical representation of the operation that has to be performed with the random number z1 to obtain the desired number k for the integration.

In rows 1 and 2, the test integral j leaves the range defined by limit values G2, G2′. In rows 3 and 4, the test integral j remains within the predetermined limits G2 and G2′. Accordingly, the operations to be performed in integrator 3 do not change in rows 3 and 4. The original operations follow from the sign of the random number z1, see the corresponding logic signal c in column 2. Therefore, from row 3 it follows that the positive number z1 can be added to the preceding integral j⁻¹, and from row 4 it follows that the negative number z1 can be subtracted from the preceding integral j⁻¹.

In rows 1 and 2, however, the test integral j leaves the range defined by the limit values G2, G2′. In row 1, the signal a therefore assumes the logic 1 state. Analogously, in row 2, the signal b assumes the logic 1 state. By logically combining these signals a, b with the third signal c, which is dependent on the sign of the random number z1, the fourth logic signal c is formed, the logic operation being performed by means of the gates 46, 47 shown in FIG. 13. When the test integral j falls below or exceeds the limits G2, G2′, the sign of the random number z1 must be changed for the integration; this is shown in column 6.

A change of the sign of z1 in row 1 and row 2 signifies a negative and a positive numerical value k, respectively, and a retention of the sign of z1 in rows 3 and 4 signifies a positive and a negative numerical value k, respectively. The desired sign of the numerical value k of column 7 is directly correlated with the logic state of the signal d of column 4, with the magnitude of k being equal to the magnitude of the random number z1.

In subcircuit 17.1, therefore, the random number z1 must be made available in positive and negative form in the respective number system according to the table of FIG. 14. This can be done by an inversion, a complementation, a suitable table, or any other suitable method, depending on the number system used. By the logic signal d, the positive or equally great negative random number is then read out as the output value k and fed to integrator 3.

The embodiment of FIG. 13 and the associated table of FIG. 14 do not, of course, exclude other methods of checking and modifying the random number z1. However, the example shown illustrates in a simple manner the function of a comparator 9.1 and a subcircuit 17.1 of the modification device 17. Compared to other methods, the strategy for meeting the predetermined limits via a sign reversal of the random number z1 is very simple to implement.

FIG. 15 shows another comparator 9.2 which checks whether the test integral j remains within the limits G2, G2′. Comparator 9, comprising a third and a fourth arithmetic unit 49, 50 and a third and a fourth comparing element 51, 52, corresponds to comparator 9.1 of FIG. 13. The output signals, that is the fifth and sixth logic signals e, f, are fed to a selection unit 10.2 which combines them via an OR gate 53. The output of this gate 53 is a seventh logic signal g, which is applied as a control signal to a second subcircuit 17.2 of the modification device 17. The signals e and f are fed as further control signals m− and m+, respectively, to subcircuit 17.2. The first and second subcircuits 17.1, 17.2 of modification device 17 are fed with the signals a, b, c and the signals m+, m−, respectively. The logic signal g controls an electronic changeover switch 55, which provides at its output the number to be integrated, k. In switch position “0”, this is the output value k of subcircuit 17.1, and in switch position “1”, this is the positive or negative maximum shift +M, −M of subcircuit 17.2. Subcircuit 17.1 is identical to subcircuit 17.1 of FIG. 13.

If comparator 9.2 of FIG. 15 detects a transgression of the limit values G2, G2′, it will initiate the return strategy R, in which the random number to be integrated, z1, is replaced by a positive or negative maximum shift +M, −N, for example. In the simplest case, the two maximum shifts are the limit values G1, G1′ contained in memory 11. The selection as to which of the two maximum shifts will be performed is determined by the control signals m+, m−, one of which is in the logic 1 state. If none of the two limits G2, G2′ is being exceeded, no maximum shift is necessary and both signals m+, m− are in the 0 state, like the resulting signal g. Accordingly, switch 55 is in position “0”.

The checking of all limits involves a large number of additions and subtractions, which partly occur in parallel and partly are dependent on preceding operations and thus occur serially. The time required for the test integrations can be compensated for by the delay unit 2 or by a pipeline technique. Another possibility is to combine separate arithmetic units into multiple arithmetic units, for example by incorporating arithmetic unit 38 into arithmetic units 42, 43. Further acceleration can be achieved by performing all arithmetic operations in parallel arithmetic units and outputting one of the results as a new integral via a specific selection unit. Such an arrangement is shown schematically in FIG. 16. Four multiple arithmetic units 60 and four single arithmetic units 70 are connected to a specific selection unit 80. The output of selection unit 80 provides the new integral pa, which is then fed to the phase-controlled oscillator 5 in clock generator 100. In the parallel-connected arithmetic units 60, 70, the operations listed below are performed, with the random number to be examined, z1, being taken into account with correct sign, that is, as a positive or negative numerical value. The following illustrates by the example of the sign reversal method the operations to be performed in parallel in the individual arithmetic units:

multiple arithmetic unit 61: j+z1−G2′,

multiple arithmetic unit 62: j+z1−G2,

multiple arithmetic unit 63: j+z1−G3′,

multiple arithmetic unit 64: j+z1−G3,

single arithmetic unit 71: j+z1,

single arithmetic unit 72: j−z1,

single arithmetic unit 73: j+M,

single arithmetic unit 74: j−M.

Although the present invention has been shown and described with respect to several preferred embodiments thereof, various changes, omissions and additions to the form and detail thereof, may be made therein, without departing from the spirit and scope of the invention.

What is claimed is:

1. A clock generator (100) comprising a random-number generator (1) and a phase modulator (4) for generating a system clock (cl) which is jittered in the frequency spectrum and thus causes minimal radiated interference, characterized by the following features:
between the random-number generator (1) and the phase modulator (4), an integrator (3) is inserted for integrating the random numbers (z1, z2) provided by the random-number generator;
the output of the integrator (3) controls via its integral (pa; j') the respective phase value in the phase modulator (4); and
the integrator (3) is coupled to a checking facility (7) which interferes in the random numbers (z1, z2) or intervenes in the integration process to prevent predetermined limit values (G1, G1′; G2, G2′; G3, G3′) of the integral (pa, j') from being exceeded.

2. A clock generator (100) as set forth in claim 1, characterized in that a first limit value (G1, G1′; cmin) and a start value (psoll; G1, G1′; G2, G2′) define a maximum jump (M; M'; M*) of the integral (pa; j') which corresponds to a maximum permissible phase shift of the system clock (cl).

3. A clock generator (100) as set forth in claim 1, characterized in that a second limit value (G2, G2′) defines a first maximum permissible phase deviation of the system clock (cl) at least during predetermined first time intervals.

4. A clock generator (100) as set forth in claim 3, characterized in that the random-number generator (1) produces random numbers (z1, z2) which lie within a predetermined range of values, particularly within a range defined by the first limit values (G1, G1′).

5. A clock generator (100) as set forth in claim 4, characterized in that during second time intervals, which preferably lie outside the first time intervals, a third limit value (G3, G3′) defines a second maximum permissible phase deviation of the system clock (cl), the third limit value being at least equal in magnitude to the second limit value (G2, G2′).

6. A clock generator (100) as set forth in claim 5, characterized in that the checking facility (7) comprises a modification device (17; 17.1; 17.2) which modifies the random number (z1, z2) prior to the integration to meet the first, second, or third limit value (G1, G1′, G2, G2′, G3, G3′).

7. A clock generator (100) as set forth in claim 6, characterized in that the modification device (17) includes a subcircuit (17.2) which implements a return strategy assigned to the third limit value (G3, G3′) to ensure that the integral (pa; j') reaches the second limit value (G2, G2′) again at the beginning of the first time intervals at the latest.

8. A clock generator (100) as set forth in claim 7, characterized in that from a first phase location range (A1), defined by the second limit values (G2, G2′), an extended phase location range, the second phase location range (A2), is formed by appending at the upper and/or lower range limits (G2, G2′) an additional range, particularly a range equal in size to the maximum jump (M).

9. A clock generator (100) as set forth in claim 8, characterized in that at least part of the arithmetic operations in the checking facility (7) and the integrator (3) are performed by means of parallel-connected arithmetic units (60, 70), and that a selection unit (80) connects one of said arithmetic units to an output for the delivery of a new integral (pa; j').

10. A method of producing a modified random number (z3; k) which is fed instead of a random number (z1, z2) to an integrator (3) in a clock generator (100) according to claim 1, comprising a first step in which it is determined that a permissible range (A0, A1, A2) is exceeded with the random number (z1, z2) during the integration, and a subsequent second step, in which:
the random number to be integrated (z1, z2) is replaced by a predetermined number, particularly a number corresponding to a predetermined maximum jump (M), or
the random number to be integrated (z1, z2) is replaced by a predetermined number sequence, or
the excess value (ps10′, ps7′) of the random number to be integrated (z1, z2) is mirrored at an associated range limit (G1, G1′, G2, G2′, G3, G3′), or
the random number to be integrated (z1, z2) is replaced by a number of the same magnitude with changed sign, or
if a third range limit (G3, G3′) is exceeded, the random number to be integrated (z1, z2) is replaced by a predetermined number with appropriate sign, particularly by a number corresponding to the maximum permissible jump (M), which permits a return to second range limits (G2, G2′) at the beginning of a first time interval at the latest, or
the random number to be integrated (z1, z2) or a sequence of the last random numbers is replaced by a repetition of the random number or of the sequence of the last random numbers with at least one changed sign, with the order during the repetition being arbitrary, or
the random number to be integrated (z1, z2) is suppressed and new random numbers are used until a suitable random number appears with which the respective range limits are met.
